(19) United States
(12) Patent Application Publication
(10) Pub. No.: US 2014/0267082 A1
(43) Pub. Date: Sep. 18, 2014

(54) ENLARGING TOUCH SCREEN PORTIONS

(71) Applicant: LENOVO (SINGAPORE) PTE, LTD., New Tech Park (SG)

(72) Inventors: Nathan J. Peterson, Durham, NC (US); John Carl Mese, Cary, NC (US); Rod D. Waltermann, Rougemont, NC (US); Arnold S. Weksler, Raleigh, NC (US); Russell Speight VanBlon, Raleigh, NC (US)

(73) Assignee: LENOVO (SINGAPORE) PTE, LTD., New Tech Park (SG)

(21) Appl. No.: 13/839,633

(22) Filed: Mar. 15, 2013

(51) Int. Cl. G06F 3/041

(52) U.S. Cl. CPC G06F 3/0416
USPC 345/173

(57) ABSTRACT

For enlarging touch screen portions, a detection module detects a selection object approaching a touch screen. The enlargement module enlarges a target portion of the touch screen in response to detecting the selection object.

### FIELD

The subject matter disclosed herein relates to touch screens and more particularly relates to enlarging touch screen portions.

### BACKGROUND

### Description of the Related Art

A touch screen may be used to provide a control interface for a digital processing system (DPS). The touch screen may be small in size and/or display small controls that are difficult to select.

### BRIEF SUMMARY

For enlarging touch screen portions, an apparatus, method, and program product are disclosed. The apparatus includes a computer readable storage medium storing machine readable code. The apparatus further includes a processor executing the machine readable code. The machine readable code may include a detection module and an enlargement module. The detection module detects a selection object approaching a touch screen. The enlargement module enlarges a target portion of the touch screen in response to detecting the selection object. The method and the program product also perform the functions of the apparatus.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of the embodiments as set forth hereinafter.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a front view drawing illustrating one embodiment of a DPS;

FIG. 2 is a schematic diagram illustrating one embodiment of a selection object and touch screen;

FIG. 3 is a schematic diagram illustrating one alternate embodiment of a selection object and touch screen;

FIG. 4 is a schematic diagram illustrating one embodiment of a selection object;

FIG. 5 is a schematic diagram illustrating one alternate embodiment of a selection object;

FIG. 6 is a schematic diagram illustrating one embodiment of a selection object, a touch screen, and a vector;

FIG. 7 is a schematic diagram illustrating one alternate embodiment of a selection object, a touch screen, and a vector;

FIG. 8 is a front view drawing illustrating one embodiment of a DPS with a target portion;

FIG. 9 is a front view drawing illustrating one embodiment of a DPS with an enlarged target portion;

FIG. 10 is a schematic diagram illustrating one alternate embodiment of a target portion;

FIG. 11 is a schematic diagram illustrating one alternate embodiment of a target portion;

FIG. 12 is a schematic diagram illustrating one alternate embodiment of a target portion;

FIG. 13 is a schematic diagram illustrating one alternate embodiment of a target portion;

FIG. 14 is a schematic diagram illustrating one alternate embodiment of a target portion;

FIG. 15 is a schematic diagram illustrating one alternate embodiment of a target portion;

FIG. 16 is a schematic diagram illustrating one alternate embodiment of an enlarged target portion;

FIG. 17 is a schematic diagram illustrating one alternate embodiment of an enlarged target portion;

FIG. 18 is a schematic diagram illustrating one alternate embodiment of an enlarged target portion;

FIG. 19 is a schematic diagram illustrating one alternate embodiment of an enlarged target portion;

FIG. 20 is a schematic diagram illustrating one alternate embodiment of an enlarged target portion;

FIG. 21 is a schematic block diagram illustrating one embodiment of a DPS;

FIG. 22 is a schematic block diagram illustrating one embodiment of an enlarging apparatus; and

FIG. 23 is a schematic flow chart diagram illustrating one embodiment of an enlarging method.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code. The storage devices may be tangible, non-transitory, and/or non-transmission.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in machine readable code and/or software for execution by various types of processors. An identified module of machine readable code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of machine readable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices, and may exist, at least partially, merely as electronic signals on a system or network. Where a module or portions of a module are implemented in software, the software portions are stored on one or more machine readable storage devices.

Any combination of one or more computer readable medium may be utilized. The computer readable medium may be a machine readable signal medium or a machine readable storage medium such as a computer readable storage medium. The machine readable storage medium may be a storage device storing the machine readable code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A machine readable signal medium may include a propagated data signal with machine readable code embodied therein, for example, in baseband or as part of a carrier wave. Such a propagated signal may take any of a variety of forms, including, but not limited to, electro-magnetic, optical, or any suitable combination thereof. A machine readable signal medium may be any storage device that is not a computer readable storage medium and that can communicate, propagate, or transport a program for use by or in connection with an instruction execution system, apparatus, or device. Machine readable code embodied on a storage device may be transmitted using any appropriate medium, including but not limited to wireless, wireline, optical fiber cable, Radio Frequency (RF), etc., or any suitable combination of the foregoing.

Machine readable code for carrying out operations for embodiments may be written in any combination of one or more programming languages, including an object oriented programming language such as Java, Smalltalk, C++ or the like and conventional procedural programming languages, such as the “C” programming language or similar programming languages. The machine readable code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by machine readable code. These machine readable code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The machine readable code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The machine readable code may also be loaded onto a computer, other programmable data processing apparatus, or other devices to cause a series of operational steps to be performed on the computer, other programmable apparatus or other devices to produce a computer implemented process such that the program code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and machine readable code.

Descriptions of figures may refer to elements described in previous figures, like numbers referring to like elements.

FIG. 1 is a front view drawing illustrating one embodiment of a DPS 100. The DPS 100 may be a mobile telephone, a tablet computer, or the like. Alternatively, the DPS 100 may be a display portion of a laptop computer, a computer workstation, a kiosk, the control panel, or the like.

The DPS 100 includes a touch screen 110. The touch screen 110 may employ technologies that include but are not limited to resistive, acoustic wave, surface capacitance, projected capacitance, mutual capacitance, self capacitance, infrared, optical imaging, acrylic projection, signal dispersion, and acoustic pulse. The touch screen 110 may display data including text, images, video, and the like. The touch screen 110 may also display hot spots 105. When touched by a selection object, the hot spots 105 may initiate an action such as launching an application, activating a function of the application, or the like.

The hot spots 105 may be small relative to the selection object and/or the touch screen 110. As a result, accurately selecting a desired hot spot 105 may be difficult. For example, a user attempting to select a first hot spot 105a may inadvertently select a second hot spot 105b.

The embodiments described herein detect a selection object approaching the touch screen 110 and enlarge a target portion of the touch screen 110. Enlarging the target portion of the touch screen allows a user to more easily and accurately select a hot spot 105 as will be described hereafter.

FIG. 2 is a schematic diagram illustrating one embodiment of a selection object 205 and a touch screen 110. The selection object 205 may be a finger, a knuckle, other portions of the body, a stylus, and the like. The touch screen 110 detects the selection object 205. In one embodiment, the touch screen 110 also determines a first distance 210a of the selection object 205 from the touch screen 110.

FIG. 3 is a schematic diagram illustrating one alternate embodiment of the selection object 205 and the touch screen 110 of FIG. 2. The touch screen 110 detects the selection object 205 and determines a second distance 210b between the selection object 205 and the touch screen 110. Because the touch screen 110 is able to determine distances 210 between the selection object 205 and the touch screen 210, the touch screen 110 can detect the selection object 205 approaching the touch screen 110.

In one embodiment, the selection object 205 is detected by a changing resistance of the touch screen 110 in response to the proximity of the selection object 205. Alternatively, the selection object 205 may be detected by a change in the capacitance of the touch screen 110 in response to the proximity of the selection object 205. In one embodiment, the selection object 205 is detected by the selection object 205 interrupting an acoustic wave. Alternatively, the selection object 205 may be detected by interrupting an optical wave such as an infrared wave, a visible spectrum wave, an ultraviolet wave, or the like. In one embodiment, the selection object is detected by a change in a piezoelectric charge in the touch screen 110.

FIG. 4 is a schematic diagram illustrating one embodiment of a selection object 205. The selection object 205 may be the selection object 205 of FIGS. 2 and 3. The touch screen 110 may determine a selection object point 220. In the depicted embodiment, the selection object point 220 is determined to be in a center of the selection object 205. In one embodiment, the selection object point 220 is determined to be in a center of a portion of the selection object 205 that is closest to the touch screen 110. For example, the selection object point 220 may be located at a center of a fingertip or a stylus.

FIG. 5 is a schematic diagram illustrating one alternate embodiment of a selection object 205. The selection object 205 may be the selection object 205 of FIGS. 3-4. In the depicted embodiment, the selection object point 220 is determined to be on an upper edge of the selection object 205. Alternatively, the selection object point 220 may be located on the lower edge of the selection object 205, on the right edge of the selection object 205, and/or on the left edge of the selection object 205. The upper edge of the selection object 205 may be a portion of the selection object 205 that is closest to the touch screen 110. For example, the selection object point 220 may be located on an edge of the fingertip, an edge of a stylus, or the like.

FIG. 6 is a schematic diagram illustrating one embodiment of a selection object 205, a touch screen 110, and a vector 215a. The selection object 205 is depicted in proximity to the touch screen 110. The touch screen 110 may determine the vector 215a from the selection object point 220 of the selection object 205 to a projection point 225 on the touch screen 110. In the depicted embodiment, the vector 215a is normal to a plane of the touch screen 110.

FIG. 7 is a schematic diagram illustrating one alternate embodiment of a selection object 205, a touch screen 110, and a vector 215b. The selection object 205 and the touch screen 110 of FIG. 6 are shown. The touch screen 110 determines a vector 215b from the selection object point 220 of the selection object 205 to the projection point 225 in a direction of travel of the selection object 205.

FIG. 8 is a front view drawing illustrating one embodiment of the DPS 100 with a target portion 245. In response to detecting the selection object 205 approaching the touch screen 110, the touch screen 110 may determine a projection point 225 on the touch screen 110. The projection point 225 may be on a vector 215a normal to a plane of the touch screen 110 that intersects the selection object point 220. Alternatively, the projection point 225 may be on a vector 215b from the selection object point 220 in the direction of travel of the selection object 205.

A target portion 245 of the touch screen 110 is determined relative to the projection point 225. In the depicted embodiment, the target portion 245 is the area within a circle centered on the projection point 225. The circle may have a target radius from the projection point 225. However, the target portion 245 may have an area of any shape and may be disposed in any direction and at any distance from the projection point 225. For example, the target portion 245 may be asymmetrically biased from the projection point 225.

In one embodiment, the target portion 245 may be user-defined. For example, a user may set one or more parameters including a shape of the target portion 245, a size of the target portion, a direction of the target portion 245 from the projection point 225, and a distance of the target portion 245 from the projection point 225.

FIG. 9 is a schematic diagram illustrating one embodiment of a DPS 100 with an enlarged target portion 250. The DPS 100 of FIG. 8 is shown with the target portion 245 enlarged into an enlarged target portion 250. The target portion 245 of the touch screen 110 is more clearly visible within the enlarged target portion 250. In addition, the selection object 205 may more accurately select a hot spot 105 within the enlarged target portion 250 because of the larger size of each of the hot spots 105.

In one embodiment, all objects, data, hot spots 105, and the like within the target portion 245 are enlarged within the enlarged target portion 250. Alternatively, only selectable hot spots 105 may be enlarged and displayed within the enlarged target portion 250.

In one embodiment, the entirety of each object, data, and hot spots 105 is enlarged if any portion of the objects, data, and hot spot 105 is within the target portion 245. Alternatively, only the portions of the objects data, and hot spots 105 within the target portion 245 are enlarged.

In one embodiment, the enlarged target portion 250 has the same shape as the target portion 245. Alternatively, the enlarged target portion 250 may have a different shape from the target portion 245. In one embodiment, both the target portion 245 and the enlarged target portion 250 are centered on the projection point 225. Alternatively, the target portion 245 may be centered on the projection point 225 and the enlarged target portion 250 may be offset from the projection point 225. In one embodiment, the target portion 245 is offset from the projection point 225 and the enlarged target portion 250 is centered on the projection point 225.

The selection object 205 may select a hot spot 105 within the enlarged target portion 250. The touch screen 110 may receive the hot spot selection by the selection object 205 of the hot spot 105 within the enlarged target portion 250.

FIG. 10 is a schematic diagram illustrating one alternate embodiment of a target portion 245. In FIGS. 10-15, the DPS 100 and whole of the touch screen 110 are not shown for simplicity. The target portion 245 is depicted as an oval centered on the projection point 225. Alternatively, center of the target portion 245 may be offset from the projection point 225.

FIG. 11 is a schematic diagram illustrating one alternate embodiment of the target portion 245. The target portion 245 is depicted as an octagon centered on the projection point 225. Alternatively, the center of the target portion 245 may be offset from the projection point 225.

FIG. 12 is a schematic diagram illustrating one alternate embodiment of the target portion 245. The target portion 245 is depicted as a square, with the square offset from the projection point 225. Alternatively, the target portion 245 may be centered on the projection point 225.

FIG. 13 is a schematic diagram illustrating one alternate embodiment of the target portion 245. The target portion 245 is depicted as a rectangle, with a rectangle offset from the projection point 225. Alternatively, the target portion 245 may be centered on the projection point 225.

FIG. 14 is a schematic diagram illustrating one alternate embodiment of the target portion 245. The target portion 245 is depicted as a triangle, with the triangle offset from the projection point 225. Alternatively, the target portion 245 may be centered on the projection point 225.

FIG. 15 is a schematic diagram illustrating one alternate embodiment of the target portion 245. The target portion 245 is depicted as an ellipse, with the center of the ellipse offset from the projection point 225. One of skill in the art will recognize that the embodiments may be practiced with any or all of the shapes depicted in FIGS. 10-15, other shapes, and various orientations of the shapes relative to the projection point 225.

FIG. 16 is a schematic diagram illustrating one alternate embodiment of an enlarged target portion 250. In the depicted embodiment, the enlarged target portion 250 is a circle enlarged to the left of the projection point 225. In FIGS. 16-20, the DPS 100 and whole of the touch screen 110 are not shown for simplicity. FIG. 17 is a schematic diagram illustrating one alternate embodiment of an enlarged target portion 245 that that is a circle is enlarged to the right of the projection point 225. FIG. 18 is a schematic diagram illustrating one alternate embodiment of the enlarged target portion 245 that is a square and is enlarged above the projection point 225. FIG. 19 is a schematic diagram illustrating one alternate embodiment of the enlarged target portion that is a rectangle and is enlarged below the projection point 225.

FIG. 20 is a schematic diagram illustrating one alternate embodiment of the enlarged target portion 250 that is a rounded triangular shape above the projection point 225. One of skill in the art will recognize that the embodiments may be practiced with enlarged target portions 250 of other sizes, shapes, and dispositions relative to the projection point 225.

FIG. 21 is a schematic block diagram illustrating one embodiment of the DPS 100. The DPS 100 may include a processor 305, a memory 310, and communication hardware 315. The memory 310 may be a computer readable storage medium such as a semiconductor storage device, a hard disk drive, an optical storage device, a holographic storage device, a micromechanical storage device, or the combinations thereof. The memory 310 may store machine readable code. The processor 305 may execute the machine readable code. The communication hardware 315 may communicate with the touch screen 110 and other devices.

FIG. 22 is a schematic block diagram illustrating one embodiment of an enlarging apparatus 400. The apparatus 400 may be embodied in the DPS 100. The apparatus 400 includes a detection module 405 and an enlargement module 410.

In one embodiment, the detection module 405 and the enlargement module 410 are embodied in a computer readable storage medium such as the memory 310 storing machine readable code. The processor 305 may execute the machine readable code to perform the functions of the apparatus 400.

Alternatively, the detection module 405 and the enlargement module 410 may be embodied in semiconductor gates. The semiconductor gates may be embodied in the touch screen 110, a discrete device, or combinations thereof. Alternatively, the detection module 405 and the enlargement module 410 may be embodied in combinations of semiconductor gates and the computer readable storage medium.

The detection module 405 detects the selection object 205 approaching the touch screen 110. The detection module 405 may include the touch screen 110. In one embodiment, the detection module 405 detects the approach of the selection object 205 by detecting the selection object 205 at a first farther distance 210a and subsequently detecting the selection object 205 and a second closer distance 210b. The selection object 205 may not contact the touch screen 110 at the second closer distance 210b.

The enlargement module 410 enlarges a target portion 245 of the touch screen 110 in response to detecting the selection object 205. The enlargement module 410 may enlarge the target portion 245 into the enlarged target portion 250.

FIG. 23 is a schematic flow chart diagram illustrating one embodiment of an enlarging method 500. The method 500 may perform the functions of the apparatus 400 and the DPS 100. In one embodiment, the method 500 is performed by use of the processor 305. Alternatively, the method 500 may be performed by a computer readable storage medium such as the memory 310. The computer readable storage medium may store machine readable code. The processor 305 may execute the machine readable code to perform the functions of the method 500.

In an alternate embodiment, the method 500 is performed by semiconductor gates. The semiconductor gates may be in a discrete device, integrated with the touch screen, or combinations thereof. In a certain embodiment, the method 500 is performed by a combination of semiconductor gates and the computer readable storage medium.

The method 500 starts, and in one embodiment, the detection module 405 detects 502 the selection object 205 approaching the touch screen 110. The detection module 405 may detect 502 all objects within a specified range of the touch screen 110. In one embodiment, the detection module 405 tracks all objects within the specified range of the touch screen 110. Alternatively, the detection module 405 may track objects that exceed a detection threshold. The detection threshold may be a change in resistance, a change in capacitance, a change in acoustic wave, a change in an optical wave, and/or a change in a piezoelectric charge.

In one embodiment, the detection module 405 detects 502 the selection object 205 approaching the touch screen 110 by detecting the selection object 205 at a first farther distance 210a and subsequently detecting the selection object 205 at a second closer distance 210b. If the detection module 405 does not detect 502 the selection object 205, the detection module 405 may continue monitoring for the selection object 205.

In one embodiment, the detection module 405 calculates the vector 215b of the direction of the selection object 205. The detection module 405 may only detect 502 the selection object 205 as approaching the touch screen 110 if an angle between the vector 215b and the touch screen exceeds an angle threshold. In one embodiment, the angle threshold is in the range of 0 to 60 degrees, where 90 degrees is perpendicular to the plane of the touch screen 110.

The detection module 405 may further determine 504 if a selection object area exceeds an area threshold. In one embodiment, the selection object area is estimated from an area of the touch screen 110 that is affected by the approach of the selection object 205. For example, if 100 square millimeters of the touch screen 110 is affected by the approach of the selection object 205, the selection object area SA may be calculated using Equation 1, where k is a nonzero constant and TA is the area of the touch screen 110 affected by the selection object 205.

SA=k*TA Equation 1

In one embodiment, the area threshold is in the range of 5 to 75 square millimeters. In an alternative embodiment, the area threshold is in the range of 10 to 150 square millimeters. If the affected area of the touch screen 110 does not exceed the area threshold, the detection module 405 may continue to detect 502 the selection object 205 approaching.

The enlargement module 410 may enlarge 506 the target portion 245 in response to detecting 500 the selection object 205 approaching the touch screen 110. Alternatively, the enlargement module 410 may enlarge 506 the target portion 245 in response to both detecting 502 the selection object 205 approaching the touch screen 110 and the selection object area exceeding 504 the area threshold. In one embodiment, the enlargement module 410 may only enlarge 506 the target portion 245 in response to determining that the angle between the vector 215b and the touch screen 110 exceeds the angle threshold. In a certain embodiment, the enlargement module 410 may enlarge 506 the target portion 245 in response to two or more of detecting 500 to the selection object 205 approaching the touch screen 110, the selection object area exceeding the area threshold, and the angle between the vector 215b and the touch screen 110 exceeding the angle threshold.

In one embodiment, the enlargement module 410 enlarges 506 the enlarged target portion 250 so that a first edge of the enlarged target portion 250 extends to an edge of the touch screen 110. In an alternate embodiment, the enlarged target portion 250 is enlarged so that a horizontal dimension of the enlarged target portion 250 is within the range of 30 to 100 percent of a horizontal dimension of the touch screen 110. Alternatively, the enlarged target portion 250 is enlarged so that a vertical dimension of the enlarged target portion 250 is within the range of 30 to 100 percent of a vertical dimension of the touch screen 110.

In one embodiment, the horizontal and vertical dimensions of the enlarged target portion 250 are specified by a control panel setting. Alternatively, the enlarged target portion 250 is enlarged to horizontal and vertical dimensions such that the hot spots 105 within the enlarged target portion 250 exceed a specified hot spot area minimum.

In one embodiment, the enlargement module 410 may persist in displaying the target portion 245 as the enlarged target portion 250 for specified persistence interval. The persistence interval may be in the range of 1 to 4 seconds. Alternatively, the enlargement module 410 may persist in displaying the target portion 245 as the enlarged target portion 250 until the selection object 205 touches the touch screen 110 and/or until the selection object 205 is withdrawn beyond a persistence range of the touch screen 110. The persistence range may be between 5 and 15 millimeters.

The detection module 405 may receive 508 a hot spot selection in response to the selection object 205 touching a depiction of an enlarged hot spot within the enlarged target portion 250 on the touch screen 110. The selected hot spot 105 may be highlighted or otherwise indicated in response to the selection. In addition, the enlargement module 410 may persist in displaying the enlarged target portion 250 for a residual interval in response to the selection of the hot spot 105. The residual interval may be in the range of 0.5 to 2 seconds.

In response to receiving 508 the hot spot selection, the enlargement module 410 may reset the enlarged target portion 250 to the target portion 245. Alternatively, the enlargement module 410 may reset the enlarged target portion 205 to the target portion 245 in response to the selection object 205 being withdrawn beyond the persistence range of the touch screen 110. The detection module 405 may then continue to monitor to detect 502 the selection object 205 approaching the touch screen 110.

By detecting 502 the selection object 205 approaching the touch screen 110, the embodiments support the enlarging of the target portion 245 of the touch screen 110 into the enlarged target portion 250 in response to the detection of the selection object 205. Hot spots 105 within the enlarged target portion 205 may be more accurately selected with the selection object 205. Thus hot spots 105 may be accurately selected on a small touch screen 110. In addition, small hot spots 105 on a large touch screen 110 may also be accurately selected.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a memory storing machine readable code;
a processor executing the machine readable code, the machine readable code comprising:
a detection module detecting a selection object approaching a touch screen; and
an enlargement module enlarging a target portion of the touch screen in response to detecting the selection object.

2. The apparatus of claim 1, the detection module further receiving a hot spot selection by the selection object of a hot spot within the enlarged target portion.

3. The apparatus of claim 1, wherein the target portion is enlarged in response to both detecting the selection object and a selection object area exceeding an area threshold.

4. The apparatus of claim 1, wherein the target portion is enlarged from a projection point on a vector from the selection object to the touch screen, and the vector is in a direction selected from the group consisting of a normal to the touch screen and a direction of travel of the selection object.

5. The apparatus of claim 4, wherein the vector is projected from a selection object point selected from the group consisting of a center of the selection object and an upper edge of the selection object.

6. A method comprising:
detecting, by use of a processor, a selection object approaching a touch screen; and
enlarging a target portion of the touch screen in response to detecting the selection object.

7. The method of claim 6, further comprising receiving a hot spot selection by the selection object of a hot spot within the enlarged target portion.

8. The method of claim 6, wherein the target portion is enlarged in response to both detecting the selection object and a selection object area exceeding an area threshold.

9. The method of claim 6, wherein the target portion is enlarged from a projection point on a vector from the selection object to the touch screen.

10. The method of claim 9, wherein the vector is in a direction selected from the group consisting of a normal to the touch screen and a direction of travel of the selection object.

11. The method of claim 9, wherein the vector is projected from a selection object point selected from the group consisting of a center of the selection object and an upper edge of the selection object.

12. The method of claim 9, wherein the target portion comprises a circular shape with a target radius from the projection point.

13. The method of claim 9, wherein the target portion is asymmetrically biased from the projection point.

14. The method of claim 6, wherein the enlarged target portion comprises each hot spot within the target portion.

15. The method of claim 6, wherein detecting the approach of the selection object comprises detecting the selection object at first farther distance and subsequently detecting the selection object at a second closer distance, wherein the selection object does not contact the touch screen at the second closer distance.

16. A program product comprising a computer readable storage medium storing machine readable code executable by a processor to perform the operations of:
detecting a selection object approaching a touch screen; and
enlarging a target portion of the touch screen in response to detecting the selection object.

17. The program product of claim 16, the operations further comprising receiving a hot spot selection by the selection object of a hot spot within the enlarged target portion.

18. The program product of claim 16, wherein the target portion is enlarged in response to both detecting the selection object and a selection object area exceeding an area threshold.

19. The program product of claim 16, wherein the target portion is enlarged from a projection point on a vector from the selection object to the touch screen, and the vector is in a direction selected from the group consisting of a normal to the touch screen and a direction of travel of the selection object.

20. The program product of claim 19, wherein the vector is projected from a selection object point selected from the group consisting of a center of the selection object and an upper edge of the selection object.
